(19) United States
(12) Patent Application Publication
(10) Pub. No.: US 2007/0027799 A1
(43) Pub. Date: Feb. 1, 2007

(54) Universal line of credit having multiple financial product features

(75) Inventors: Jim J. Manelis, Phoenix, AZ (US); Rosanne F. Russell, Zionsville, IN (US); Darrin M. Rosamond, Tampa, FL (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: JPMorgan Chase Bank, N.A., New York, NY (US)

(21) Appl. No.: 11/311,261

(22) Filed: Dec. 20, 2005

Related U.S. Application Data
(60) Provisional application No. 60/703,499, filed on Jul. 29, 2005.

(51) Int. Cl. G06Q 40/00

(52) U.S. Cl. 705/38; 705/35

(57) ABSTRACT

According to various embodiments, a system and method for providing a financial account associated with a customer asset are provided. A financial account containing funds is established for a customer. At least a portion of the funds are secured by property owned by the customer. The account enables the customer to draw funds from the account up to a credit limit, transfer funds from the account to another entity, and deposit funds into the account. After the account is established, an appraised value of the property is determined. The credit limit is automatically changed based on the determined appraised value.

### RELATED APPLICATIONS

This application claims the benefit of U.S. Provisional Application No. 60/703,499 filed Jul. 29, 2005, the disclosure of which is incorporated herein by reference in its entirety.

### FIELD OF THE INVENTION

The present invention relates to a single financial account that can be used for multiple financial purposes.

### BACKGROUND OF THE INVENTION

Most conventional financial accounts provide customers a single account for a single purpose. For instance, conventional banks typically offer checking accounts, savings accounts, investment accounts, and financial products such as mortgages and home equity lines of credit in separate customer accounts. Even though one customer might have a checking account, savings account, and home mortgage from the same banking institution, each of these financial products would remain separate and independent. Because each customer account is typically separate, the features and terms of any single account are typically independent of the activity of any other customer account. For instance, the interest rate of a customer's savings account is typically fixed or tied to a rate that does not depend on the balance of a customer's credit card account. Similarly, a variable rate mortgage may require a monthly payment based exclusively on a pre-determined amortization schedule and a variable prime rate, and it may be completely independent of a customer's other accounts.

More recently, banks enable customers to link various accounts together. For instance, a customer may have linked checking, credit card, and savings accounts so that a customer may easily transfer funds between the various accounts and access transaction information on one webpage rather than three. Also, multi-function accounts enable customers to accomplish two or more financial goals in a single account, such as a money market account that earns interest like a savings account while earning the customer interest.

### SUMMARY OF THE INVENTION

According to various embodiments, a system and method for providing a financial account associated with a customer asset are provided. A financial account containing funds is established for a customer. At least a portion of the funds (e.g., all of the funds) are secured by property owned by the customer. The account enables the customer to draw funds from the account up to a credit limit, transfer funds from the account to another entity, and deposit funds into the account. After the account is established (or before or at the same time), an appraised value of the property is determined. The credit limit may automatically be changed based on the determined appraised value. In addition, the insurance could also be adjusted (e.g., upwards) based on the appraisal value.

According to another embodiment of the invention, a system for providing a financial account associated with a customer asset (e.g., a house) is provided. An account creation module establishes for a customer a financial account containing funds. At least a portion of the funds are secured by property owned by the customer. The account enables the customer to draw funds from the account up to a credit limit, transfer funds from the account to another entity, and deposit funds into the account. An appraisal module determines an appraised value of the property after the establishing action. A credit module may automatically refresh or otherwise change the credit limit (or stored value account limit) based on the determined appraised value.

According to another embodiment of the invention, a method for providing a financial account associated with a customer asset is provided. A financial account containing funds is established for a customer. At least a portion of the funds are secured by property owned by the customer. The account enables the customer to draw funds from the account up to a credit limit, transfer funds from the account to another entity, and deposit funds into the account. A request to lock in an interest rate associated with the at least a portion of the secured funds is received. An amortized schedule of payments owed by the customer for the at least a portion of the secured funds is determined. The schedule of payments is re-amortized based on customer behavior. A credit card configured to charge transactions against the account is issued to the customer. A request made by the customer for cash drawn against the account is received from an ATM machine. An appraised value of the property is determined after the establishing action. The credit limit is automatically changed based on the determined appraised value.

Other embodiments may be considered.

### BRIEF DESCRIPTION OF THE DRAWINGS

FIG. 1 shows an exemplary system for providing an account with multiple financial product and/or account features.

FIG. 2 shows an exemplary method of providing a financial account associated with a customer asset according to an embodiment of the invention.

### DESCRIPTION OF EXEMPLARY EMBODIMENTS

According to an embodiment of the invention, a financial account is provided that provides the features of a plurality of financial accounts and/or financial products. In one exemplary embodiment, a single home equity account may have a credit and checking feature, wherein the account may be used for conventional purposes such as credit card and check purchases. In some embodiments, a single account is provided through which a consumer can fund all of the consumer's expenditures. In this way, a single account may replace a traditional mortgage, car loan, checking account, credit card account, stored value account, online billpay, insurance, and/or other financial products and services.

Some embodiments of the present invention are directed to a single account utilizing a variety of banking products and services, including a home mortgage, home equity line of credit, credit card, stored value card, online banking, and/or ATM card. For instance, in addition to using the account as a checking account, credit card account, stored value card account, and/or online bill pay account, the account can be used to purchase property such as a house, obtain a home equity line of credit several years after the purchase, and then transfer the mortgage securing the account to another home purchase several years after that. The account can draw on accumulated equity in the house as well as other credit. For instance, a customer account holder may draw on funds from a home equity line of credit (HELOC) by making withdrawals at an ATM machine.

The account may be referred to herein as an “universal line of credit” or “ULOC.” A ULOC is defined herein as an account (or account feature) having at least one of the following features: locked (and/or unlocked) loan or credit secured by one or more assets (such as real property, securities, or other assets), or unsecured, or a combination thereof; a first lien position (or alternately or in addition, a second or more junior lien position); a mortgage product (including hybrid mortgages such as shared appreciation mortgages) or other home financing products; home credit or equity product, such as a home equity line of credit; auto loan or equity product; insurance account or payment feature; checking account; credit card account; debit card account; stored value card account; account access device such as a card, biometric device, RFID, or other key fob; general consumer credit product; portability feature (as described herein); dynamic re-amortization feature (as described herein); one or more rewards/loyalty programs; dynamically changing credit limit, available funds, or other amounts based on property/asset appreciation; “construction to perm” feature (as described herein); reporting functionality, such as the reporting functionality of a conventional bank or credit card account; the ability to effect transactions and fund transfers, e.g., online transactions, billpay, and money movement; student loan or other education financing feature; bridge loan feature; and charity or donation financing feature (as described herein).

Various embodiments of the invention provide a single ULOC account that accommodates different financial needs over the course of a customer account holder's entire lifetime. The account may be used for different purposes at different times or stages of customer's life. For instance: the account can be used (e.g., primarily) to fund a college education or other living expenses while a customer is a student in college; the account can be used (primarily) as an investment or savings account while the customer is saving to buy a house; the account can be used to finance the purchase of a house (e.g., the account may have a mortgage feature); the account may be used to withdraw equity from a purchased home (e.g., the account may have a home equity line of credit feature); the account may be used to finance the purchase of another house, e.g., using cash, credit, and/or secured or unsecured loans, and/or by transferring a mortgage from the first house to the second house; the account may be used to plan for retirement (e.g., the account may have an investment account component); the account may be used for estate planning (e.g., the account may have a trust fund feature or other system of distributing funds to other accounts or sub-accounts). The account may have one or all of these features simultaneously, as well as other features described herein.

One or more accounts according to the present invention may have one or more financial product features. Several features that may be accommodated by an account are described in the examples below.

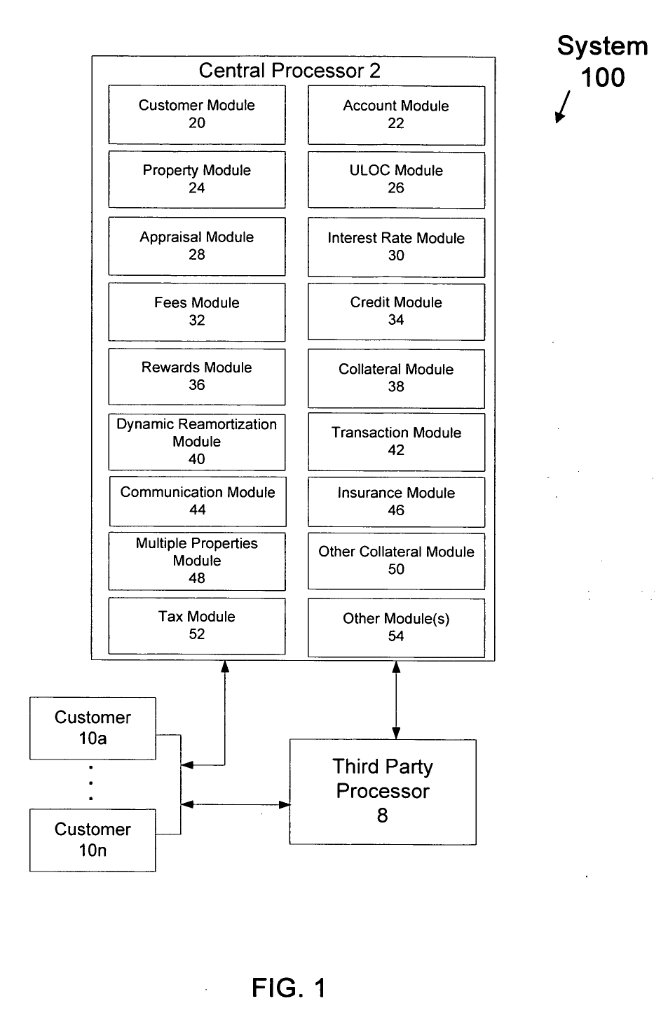

FIG. 1 shows an exemplary system 100 for providing an account with multiple financial product and/or account features. As shown in FIG. 1, central processor 2 may communicate with one or more customers 10 and one or more third party processors 8. Third party processors may comprise financial entities such as banks, ATM machines, merchants, appraisers, and other financial entities.

Each customer 10 may comprise an account holder such as a customer of a bank or a purchaser of property. The central processor 2 may comprise a financial entity such as a bank computer system that manages one or more customer 10 accounts. For instance, the central processor 2 may comprise a bank computer system that provides and manages a customer 10 account associated with a specific property such as a customer home.

The central processor 2 may comprise any server, computer system, data processing system, financial account provider system, reward engine, network account provider or manager, hub, centralized processing system, or other entity in a network. In some embodiments, the central processor may be in a location that is remote from at least one terminal 8a and/or the merchant store. Although a single central processor 2 is depicted, it should be appreciated that multiple central processors 2 may be provided and that such multiple processors 2 may share data and operational tasks to achieve efficiency and operation of the functions described herein. The central processor 2 may also comprise a content provider system. The central processor 2 may comprise input and output devices for communicating with other various system 100 elements.

Central processor 2 may manage customer account information. Central processor 2 may store customer and account-related information in any of a plurality of databases, which may or may not be comprised in various modules of central processor 2.

Customer module 20 may enroll customers 10 in an account. Customer module 20 may also determine and track customer information, such as personal information, preferences (such as preferences related to payment schedules for servicing a loan or line of credit), and other customer information.

Account module 22 may track and determine account information. Account information may comprise any information related to an account, such as balance information, transaction history, billpay information, linked accounts, and other account-related information.

Property module 24 may track and determine information related to a property, such as a property owned by customer that secures funds in the account. Such information may include insurance information, financing information, liens and other interests, ownership information, date of purchase, and other information related to a property.

ULOC module 26 may track and determine information about any loans, lines of credit, mortgages, or other financial products or services related to property, e.g., real property owned by customer 10. Such information may include balances (such as principal balance or amount of credit), interest rates, payment schedules, financing information, credit scores (e.g., of the customer 10), and other information related to a ULOC.

Appraisal module 28 may track and determine value information related to a property. For instance, appraisal module 28 may determine and/or estimate an appraisal value of the property, e.g., a property that is tied to a geographical area using a computer that refreshes or otherwise changes the appraisal value, e.g. on a periodic (or other time) basis. Appraisal module 28 may make such determinations based on value information such as property value information for other properties in the same neighborhood or otherwise related to the funds-securing property associated with the account. Any methods of appraisal are contemplated herein, such as obtaining information from a third party processor 8 or third party human appraiser 8. In some embodiments, an appraisal may be determined based on any of the following, for example: whether the house has a premium house/home feature such as a finished basement, deck, or swimming pool; a feature that distinguishes the house from comparable houses; and the performance and/or quality of the home's school district (e.g., whether a school associated with the property has been recognized for outstanding achievement).

Interest rate module 30 may determine, lock, and unlock interest rates for some or all of the funds in an account secured by a particular property (or a plurality of properties). For a particular financial product like a loan or HELOC, interest rate module 30 may lock and unlock different rates any number of times. Interest rate module 30 may also lock and unlock different rates for any number of assets (e.g., two houses and an investment fund) in the same account. A variety of loans, lines of credit, and other financial accounts having an associated rate may be locked and unlocked. In some embodiments, a plurality of loans may be pooled together and their rate may be locked into a single rate. In this way, a plurality of different financial instruments may be consolidated without refinancing. The available rates (at which a payment schedule may be locked) may be based on a market interest rate, such as the prime rate or other metric. It is appreciated that any interest rates may be used. The consolidated instruments may be un-consolidated, e.g., into a different set of instruments. One or other instruments may later be consolidated (and/or unconsolidated) throughout the life of the account.

In some embodiments, locks (e.g., debt associated with a fixed or “locked” rate) or portions thereof may be bundled together and securitized on a secondary market. For instance, a portion of a line of credit may be locked, and that portion may be securitized on the secondary market. In some embodiments, only the lock portion (and not the HELOC portion) may be securitized. The debt (and/or bundles of debt) may accordingly be sold to third parties, such as institutional investors.

In some embodiments, different users associated with the account may have different rights, privileges, and ownership with respect to the account. For instance, a parent may be the “owner” of an account with full (or only slightly limited) control of an account. The parent may establish a global line of credit. The parent's one or more children may have rights (e.g., through a sub-account) to only a “locked” portion of funds, or the one or more children may have other limited access to the account as designated by the parent. The child may accordingly draw funds on the locked portion (or otherwise use funds in the account or subaccount as specified by the parent). In some embodiments, one or more children (or others having limited rights to the account) may each have their own (or shared) stored value account linked to the account or otherwise as part of the account. In some embodiments, the stored value account may comprise funds from a HELOC or other funding source associated with the ULOC.

In some embodiments, different users on the account may have different credit limits, e.g., based on their “permissions” on the account, the preferences of the account owner, the particular user's credit score or age, or other factors associated with the account or individuals associated with the account.

In some embodiments, different account users may have different credit limits (or different amounts of available stored value). One or more users who have access to a stored value in the account (such as an equity line) may or may not also be associated with another portion of the account, such as a mortgage portion of the account. For example, a parent account owner may obtain a ULOC and designate a portion of the funds into a subaccount for a child who goes to college. The ULOC (or portion thereof) may be serviced by the parent and/or the child, and/or any other person on the account, depending on how the account and ULOC (or other account feature) is set up.

Fees module 32 may determine and charge fees to the account, e.g., for late or missed payments. Fees module 32 may determine and/or implement criteria or rules that govern when fees may be charged.

Credit module 34 may increase (or decrease) credit associated with the account, e.g., based on a determined appraisal value of the property. This feature is described further in Example 2, below.

In some embodiments, credit module 34 may change a rate, a line of credit, or other account-related feature or term (or feature or term of a portion of the account, such as a line of credit secured by a specific asset) based on any of the following, for example: a customer's credit rating (which may be measured or determined at various times), a change in the customer's credit rating, a customer's account behavior, performance of one or more account assets, customer payment history, employment history, income, credit performance, a credit policy rule, and other factors. For instance, an account credit limit may be increased based on a determination that the customer's credit rating has increased or that the customer has made 24 on-time payments in a row. Credit module 34 may determine and implement credit policy rules that govern account-related credit.

Rewards module 36 may determine reward information in an account based on reward-earning behaviors and triggers. Rewards may be implemented in any fashion as described herein.

Collateral module 38 may identify, track, and switch collateral associated with funds in the account. For instance, collateral module 38 may switch collateral for the funds from one property to another, so that funds previously secured by one property (or group of properties) are secured by a second property (or group of properties). For instance, collateral module 38 may secure funds by an property associated with the account, such as stocks, mutual funds, hedge funds, any sort of account, real assets, and intangible assets (e.g., patents, trademarks, copyrights, and other intellectual property).

In some embodiments, an account may be associated with one property, such as Property A. The account may comprise a ULOC (or other interest) secured by or otherwise associated with Property A. The account holder/customer may decide to purchase Property B, e.g., using funds (or a portion of funds) from the ULOC secured by Property A. The collateral for the ULOC may be switched from Property A to some combination of Properties A and B (and/or portions thereof). For instance, the collateral may switch from being entirely (100%) secured by Property A to being 75% secured by Property A and 25% secured by Property B. The collateral for the ULOC may switch at some time (e.g., at a later time) from the combination of Properties A and B to a different combination of Properties A and B (e.g., 50%-50%). In some embodiments, the collateral secured by Property A may eventually be switched entirely to one or more different assets (such as Property B) as the lien against Property A is withdrawn, forgiven, or otherwise eliminated. The bank may not completely forgive an old lien until a new one is in place, such that secure funds are never left unsecured. As demonstrated by this example, the collateral mixture for a specific account feature (such as a ULOC) may switch from one or more properties to one or more other properties, any number of times and at any time. It should be appreciated that such dynamic collateralization may enable the customer to use one or more properties to finance the purchase of one or more different properties.

It should be noted that the value in the account (and/or the value of the ULOC or other account feature) may increase or decrease based on the amount of collateral (e.g., the total amount of funds secured by assets associated with the account, such as the value of Property A plus the value of Property B when both are secured in the account).

Dynamic re-amortization module 40 may dynamically determine payment information, such as a payment schedule. The payment information may be determined in real time. Accordingly, re-amortization module 40 may re-amortize a payment schedule based on a missed payment or an overpayment. Re-amortization module 40 may also prompt for, receive, and process payment preference information.

Transaction module 42 may enable various transactions associated with the account, such as ATM withdrawals, credit card transactions, stored value card transactions, money orders, transfers, bill payments, online transactions, and other transactions associated with the account.

Communication module 44 may pass and receive information to and from customers 10 and third party processors 8. For instance, communication module 44 may provide account statement information (including reward information) to customers 10, e.g., via email or webpage. Communication module 44 may prompt for, process, and implement customer preferences related to the customer account.

Insurance module 46 may determine insurance rates, e.g., based on a dynamically changing value of a property. For instance, insurance module 46 may determine a new insurance premium for a house each time a home is appraised or at another time (such as each time the account holder obtains a new loan or line of credit (or other financial product) secured by the house. Adequate insurance may be required as a condition to financing, in some cases. Insurance module 46 may also enable the account or account holder to manage payments of an insurance premium, e.g., by auto-paying or auto-deducting the premium from the account each month. In some embodiments, insurance module 46 may also automate the processing of claims against the insurance.

In some embodiments, the amount or coverage of insurance may fluctuate as the value of assets or funds associated with the account fluctuate. For instance, as an account holder/owner takes more money out of a house (e.g., via a ULOC or traditional HELOC), the amount of insurance on the house required by the account may increase.

Multiple properties module 48 may enable an account to be associated with a plurality of different accounts. For instance, several different ULOCs (e.g., or traditional HELOCs) may be obtained in a single account, each associated by a different (or the same) property. Multiple properties module 48 may also automatically securitize a plurality of locks or other financial instruments associated with one or more accounts.

Other collateral module 50 may “switch” collateral of one or more financial instruments (such as a loan or ULOC) from one asset to another. For instance, a loan secured by one property may be converted so that it is secured by a different property. In some embodiments, a loan may be converted so that it is secured by a plurality of different interests in one or more different properties or other assets. For instance, a loan originally secured by a single-family home may be converted so that it is secured instead by a first lien against a condo and a second lien against a boat.

Tax module 52 may process tax-related information associated with an account. For instance, tax module 52 may cause a cash amount to be donated or otherwise transferred to a charity (or other entity), e.g., in the name of one or more account holders. Tax module 52 may determine whether any such transfer to a charity (or other entity) may be tax-deductible to the account holder (or other person). Tax module 52 may also dynamically adjust a payment schedule (e.g., associated with a ULOC) to accommodate a higher (or lower) tax liability. Tax module 52 may also automatically determine a depreciation associated with a property associated with an account. For example, tax module 52 may determine a depreciation of a house based on a rental arrangement in the house. Tax module 52 may determine any tax consequences and also determine any corresponding changes in the real value of the house based thereon (e.g., in conjunction with appraisal module 28).

Other module(s) 54 may accomplish other functions.

As shown in FIG. 1, an account processing system (e.g., a bank account management system) may communicate (e.g., over a network) with customers, a database (e.g., for storing account information such as account reward information), third parties (such as credit bureaus and merchant partners), and other financial institutions (such as other banks and providers of loans, credit, or equity, or other financial-related entities). The account processing system may accomplish any of the functions described herein.

The system 100 may enable any one or more of the following account features and functionalities described in, including but not limited to the features and functionalities described in the following examples.

### EXAMPLE 1

In some embodiments, a customer 10 may obtain a ULOC associated with property (e.g., real or personal property for which an interest is owned by—or otherwise associated with—the customer 10). For instance, the customer 10 may obtain a home equity line of credit (HELOC) in the account secured by the customer's home. The account may accordingly contain the HELOC funds (or other equity-based credit). The customer 10 may use (e.g., draw on) the HELOC funds, e.g., in the same manner the customer 10 might use the funds in a regular checking account. In some embodiments, the customer 10 may obtain a first or second mortgage (or other financial instrument) to purchase the home. The customer account may provide for any financing feature associated with the financing and refinancing of a home (or other property) purchase.

The customer may lock-in a rate on the ULOC. For instance, the customer may lock in a 30-year fixed rate of 6.0% or a 5/1 ARM rate of 5.5% on a $100,000 ULOC balance. The ULOC may have an associated payment schedule according to the locked rate and ULOC balance. Any type of rate lock-in and payment schedule is contemplated herein, e.g., as used in the loan (e.g., mortgage) industry. In some embodiments, the customer 10 may lock in only a portion of the ULOC. For instance, the customer may lock in a 30-year rate for $60,000 of the $100,000 principal, and the remaining $40,000 may have a variable rate, a 5/1 ARM, or other rate provision. In some embodiments, the customer's ULOC may have more than one HELOC (or other equity-based credit line).

In some embodiments, a fixed or variable rate may be based on a variety of factors associated with the account, account holder, and/or associated asset or assets. For example, if the account contains (or is otherwise associated with) a HELOC or mortgage, the rate may be influenced by the type of property, whether it is a vacation home or primary residence, whether the property is rented by one or more other people, whether the property is improved or unimproved land (and the extent of any improvement), the vacancy rate, the school district (and quality thereof), the existence of a finished basement or swimming pool or other valuable home feature, neighboring conditions, other market conditions, and any other financial or other factor associated with the value of the property or other financial consideration.

The customer 10 may also subsequently un-lock and/or re-lock the rate a plurality of times. For instance, a rate may be locked for a portion of the ULOC's duration, unlocked, locked again at a lower rate, and then unlocked again. At each lock and/or unlock, a different portion may be locked or unlocked. For instance, a customer 10 may unlock a $40,000 ULOC balance and then lock a $60,000 balance (that includes the $40,000 sum). In some embodiments, interest rate structures for “locked” portions may be comparable to first mortgage pricing options (such as 30-year mortgages, 15-year mortgages, adjustable rate mortgages, interest only mortgages, etc.). Multiple locks for multiple corresponding loan instrument amounts may be established concurrently. Lock and unlock fees may or may not be charged.

A security interest associated with the ULOC may be sold to another financial institution. For instance, locks may be pooled, sold and/or hedged on a secondary market.

### EXAMPLE 2

In some embodiments, available credit to the customer may be programmatically increased, e.g., based on a determined increase in the value of the customer's home or other property (e.g., property that used to secure funds in the account). This determination may be based on, e.g., local market conditions and/or other factors as discussed herein. Central processor 2 may automatically determine a value of the property. For instance, central processor 2 may determine a value based on a variety of data such as aggregate census data, home purchase data (e.g., for recent purchases in the neighborhood of a target home property), interest rate data, and other information. For instance, the central processor may determine that a customer home securing a ULOC has risen in value by 3% over the past year based on a determination that average sale prices in the home's zip code have risen by 3%. Accordingly, the system 100 may automatically determine the increased credit limit without requiring a re-financing. Increases may be determined automatically, e.g., using pricing formulas tied to various financial information.

Various computer systems and programs may use market data and other data to determine the value of a home (or other asset). In some embodiments, a LTV (loan-to-value) may be established (e.g., by a human or via an automated system that determines home values based on comparable properties and other market-related data) at the time of origination of a loan or credit instrument associated with a house or other asset. Increases may also be determined by human and/or computer appraisers and other systems and methods known in the art. Insurance coverage and premiums associated with the asset may also be adjusted according to the newly determined asset value. For instance, an insurance premium may increase in order to cover the increased risk of loss associated with a higher home value. Insurance may be handled inside the account. For example, insurance may be provided by an entity associated with the account provider (such as a bank partner), and the insurance premiums may be paid automatically or otherwise directly via the account.

The determined value may be used as collateral. For instance, at the time of purchase, 100% of a customer's home purchase price may be deemed “available credit” for the home purchaser (and customer), such that the home purchaser may draw on funds up to a total of 100% of the fair market value of the property (including first and second mortgages). Here, the fair market value may initially be determined by the sale price. Over time, the credit limit may be gradually increased according to a determined increase in home value. For instance, the credit limit may increase by the same percentage (e.g., 3%) as the determined increase in value. In some embodiments, the credit may increase based on the determined total dollar increase. For instance, if a $300,000 home is determined to increase 3% to $309,000, the credit line may increase by the full increase ($9000) or half of the increase (e.g., $4500).

(Similarly, a credit line associated with property may be decreased if the property is determined to decrease.) In cases where market conditions indicate inflated or over-valued housing prices, a limit may be placed on the amount of equity that may be drawn from an asset such as a house. This way, if the property value drops by some amount (e.g., less than 20%), most or all of the equity will still be secured by the property. Accountholders would effectively be prevented from taking too much money out of a house, for example. In some embodiments, financial derivatives based on the lender/equity-provider may be hedged. For example, the account-providing bank (or other entity) may buy or sell calls, puts, or other derivatives to hedge against any asset associated with the account (or set of accounts). For example, if the Bank provides ULOCs to a large number of homeowners, the bank could purchase derivatives to hedge against a dramatic downturn in the housing market (e.g., if a large number of homes of, a particular type or in a particular region drop significantly in value).

The credit increase may be capped, e.g., at some time during the life of the account. For instance, the increase may be immediately capped at 125% of the property's fair market value as determined at the time the account is established. For instance, five years after home purchase, the customer may have access to credit up to 125% of the original property value. The 125% credit may stop increasing at year five, e.g., until a refinancing or other financial event relating to the house (such as a sale).

In some embodiments, at the closing of an asset purchase (such as a home purchase), the Bank or other financial institution providing transaction funds may obtain a lien against the asset that is larger than 100% of the value of the purchase (e.g., 110% or 125%). For instance, a bank may finance the purchase of a $100,000 home and obtain at closing a lien against the home in an amount of $110,000. One advantage of such liens and other financial instruments is that the bank may avoid time and labor costs associated with future account activity related to the property. For instance, as the home increases in value (e.g., to $105,000 in one year), the purchaser may obtain a loan or line of credit based on the increased value without requiring the bank to obtain another lien to secure the additional funds. In some embodiments, different liens may be obtained at different times to secure more (or less) of an asset's value, and these liens may or may not be correlated in time with any financial activity of the customer (such as applying for a ULOC).

In some embodiments, a lien may be obtained that changes over time. For instance, a dynamic lien may have the property that value of its interest in the property may change over time, e.g., as the value of the property changes. For instance, the lien may have a value of $100,000 at the time of purchase and a value of $130,000 based on an appraisal that the value of the property has increased by 30%.

### EXAMPLE 3

In some embodiments, a rewards program may be implemented on the account. For instance, account holders (e.g., customers 10) may earn rewards for card transactions on the ULOC account above a pre-determined amount. For instance, customers 10 may earn rewards for each transaction above $500. Customers 10 may also earn rewards based on account activity and other customer behaviors. For instance, rewards may be granted for using the account with merchant partners of the account provider (e.g., an account-providing bank). For instance, a reward may be granted for purchasing more than $50 from a specific retailer partner.

Any known reward systems and methods are contemplated herein, including those described in commonly assigned U.S. patent application Ser. No. 10/683,294 filed Oct. 14, 2003 under attorney docket number 47004.000226 and entitled “SYSTEM AND METHOD FOR GRANTING PROMOTIONAL REWARDS TO CREDIT ACCOUNT HOLDERS,” U.S. application Ser. No. 10/683,294 entitled “REWARDS PROGRAM SYSTEM AND METHOD” filed Aug. 12, 2005 under attorney docket number 47004.000329, and U.S. application Ser. No. 11/221,706 entitled “TERMINAL FOR IMPLEMENTING SIMULTANEOUS REWARD PROGRAMS” and filed Sep. 19, 2005 under attorney docket number 47004.000343, the disclosures of which are incorporated herein by reference in their entireties. Other features of the invention may also use the systems and methods described in the above-referenced application.

Grace periods for monthly ULOC payments may be granted, e.g., based on account activity or reward points earned by using the account as a credit card for purchases. Grace periods may be granted for a monthly account access vehicle. Such grace periods may be granted as a matter of course and/or as rewards based on customer behavior.

In some embodiments, customers may use their earned rewards points for making charitable contributions. For instance, an account management system may enable customers to make online transfers to an account of a charity selected by the customer. In some embodiments, a customer may select a charity, e.g., from a predetermined list of charities or from a list of charities created based on customer information (such as a customer's preferences, address, age, etc.). In some embodiments, the customer may earn rewards (e.g., accrued to the account). The customer may select a particular type of reward (such as a cash reward or a gift reward). In some cases, the customer may “receive” a reward by having a cash (or other) donation made to a charity (e.g., a charity designated by the customer). The donation may be made in the customer's name, e.g., so that the customer may receive a corresponding tax benefit (e.g., by deducting the amount of the cash donation from the customer's income as a tax deduction), e.g., to the extent such deduction complies with applicable tax rules.

In some embodiments, different rewards may be granted to different classes of customers, such as customers that pay different yearly fees. Customers may have the option of selecting different rewards programs for each of several cardholders on the account.

### EXAMPLE 4

In some embodiments, the central processor 2 may enable customers to donate funds to a philanthropic organization, e.g., an organization of the customer's 10 choice. Donations may be made in the name of the customer, such that the customer is able to deduct the donation as a charitable contribution on his/her tax returns. For instance, the central processor 2 may enable a customer 10 to donate a portion (e.g., a percentage) of amounts charged to the account, a portion of the customer's 16 rewards (e.g., frequent flyer miles or points), or a straight donation of account funds (such as ULOC funds).

### EXAMPLE 5

In some embodiments, the account may be portable to other collateral. For example, a HELOC (or other feature of a ULOC) secured by one property (e.g., a customer's 10 home) may be converted into a HELOC secured by another property (e.g., another home owned by the customer 10). In this way, the property (or other asset) associated with a ULOC on the account may be substituted (in whole or in part) for one or more other properties (or other asset). Accordingly, in some embodiments, the mortgage securing an account may be transferred from one property to another. For instance, a target home can be purchased using a credit draw from a ULOC on an existing house, e.g., a house presently owned by customer 10. Once the target house is acquired (e.g., by customer 10), the collateral for the ULOC can be switched from the existing house to the target house. In other words, the target house may become the new collateral for the existing debt.

In some embodiments, debt and credit instruments in the account may be transferred and/or converted to facilitate a transaction wherein a customer sells one property in order to acquire a second property using all or some of the sale proceeds. In some embodiments, a bank account-provider may extend a temporary oversized HELOC or loan in order to facilitate the transaction. For instance, the central processor 2 may temporarily increase the available funds in the account so that the customer 10 can acquire the target property before the sale is finalized for the first sale, the proceeds of which are intended for use on the target property or properties (but which are currently unavailable). The bank or account may have or utilize an escrow feature so that full right and title to the property does not realize until after the temporary loan or other funds (if any) are repaid or otherwise satisfied. In some embodiments, there may be multiple target properties.

### EXAMPLE 6

In some embodiments, the account may implement dynamic re-amortization of amounts owed. In this way, the customer may manage the account's cash flow, monthly payments, and the like. For instance, if the customer would prefer to pay a smaller monthly payment in a specific month, the monthly cost schedule (e.g., for the year or other time period) can be re-calculated accordingly. For instance, subsequent monthly payments for the year may be increased to account for the lesser payment in a given month, without assessing late fees. Also, a 10-year (or other time) payment plan may be dynamically converted to a 20-year (or other time) payment plan, and vice versa.

In some embodiments, one or more of the “locks” may be bought and sold on a secondary market (e.g., as securitized assets). A set of locks (and/or other securitizable assets associated with the account) may be bundled together prior to securitizing them. The locks may be from one or more accounts, and the accounts may each be associated with account holders having the same or different geographies and demographic data. For instance, locks associated with customers having above a certain credit score, home value, or income may be bundled together. Other attributes of the customer, account, or lock may also be considered in selecting a group of locks to bundle, such as the principal amount of each lock. In some embodiments, multiple locks from a single customer and/or account may be bundled together and sold on the secondary market.

In some embodiments, funds may be drawn (e.g., via loan or HELOC or other instrument associated with a ULOC) to purchase land or a house (or other asset), and additional funds may be subsequently drawn (e.g., via loan or HELOC or other instrument associated with a ULOC) to improve the asset (e.g., by building a home on a purchased property). For example, in the account the customer may obtain funds through a personal (e.g., unsecured loan) and/or a loan secured by assets (such as a 401(k) account) to purchase land. The customer may obtain additional funds through the account to build the house, such as by obtaining additional funds in the ULOC secured by an increase in the value of the land. In another example, a customer may obtain a ULOC secured by an existing house to purchase land. The customer may later draw funds from the same house to build the house, on an ongoing basis. The customer may repay the ULOC (or otherwise service the ULOC) according to the outstanding principal balance of the ULOC—instead of obtaining a large loan at the time of purchase or the time of building and then paying down the loan from day one. All or a portion of the ULOC may have a variable rate or a locked rate that is determined, e.g., at the time of establishing the ULOC. By using a ULOC in this example, the customer only pays for the use of money as the customer uses the money, rather than prior to use. This may be ideally suited for situations where a house may be built over a long period of time, such as 1-4 years. Another benefit is that the customer may determine the interest rate in advance so that a house that is purchased and effectively paid for at a later time may by financed according to a prior rate. Thus, a home buyer or builder would not be subject to unpredictable changes in the interest rate after establishing a plan to build the house. In some embodiments, the rate may be variable until the home is complete, and at the time of completion the ULOC (or portion thereof) may be locked, converted into an ARM or other mortgage, or otherwise refinanced. During this process, appraisals may be used to determine financing features, and the appraisals may occur at different points in time (e.g., at the time of purchasing land or submitting and/or approving a home building plan, at the time of breaking ground, at a milestone of construction, or at the time of home completion). In some embodiments, an appraisal for an as-completed value may be used.

In some embodiments, the customer may provide preferences about payment timing. An account provider system may generate options according to the preferences. The options may be based on a variety of different fixed or dynamic payment schedules. The payment schedules may be any payment schedule, such as those used for fixed and variable rate mortgages. The payment terms and options of the various alternatives—some of which may typically require a refinancing—may be dynamically implemented and changed during the lifetime of the account without refinancing the specific account. Thus, a customer may select a different payment plan (e.g., with a longer term) without refinancing the ULOC.

For instance, the customer 10 may request to pay equal monthly payments in a given year (or other time period) to service a ULOC (or portion thereof, such as a HELOC portion of the ULOC). During the third month, the customer 10 may instead elect to make a lower payment for that month. The account may accordingly charge a late fee or other related fee. However, in some embodiments, the central processor 2 may re-calibrate the monthly payments so that the full amount (in time-adjusted dollars) is paid within the year (or other time period). A new payment schedule may accordingly be calculated. The new payment schedule may or may not implement a late fee.

In some embodiments, the customer 10 may express preferences regarding any new payment schedule. For instance, the customer 10 may request a payment schedule that requires smaller payments at the beginning of the time period and larger payments at the end of the time period. Alternately, the customer 10 may prefer to pay more earlier and less later, alternate large and small payments, change the frequency of payments, or otherwise change the payment schedule. Any new payment schedule is contemplated herein, and it may be dynamically calculated, e.g., upon each new payment by the customer 10. In some embodiments, instead of (or in addition to) charging a fee for delinquent payments, the central processor may simply re-calculate a new payment schedule with the same (or longer or shorter) time duration.

In some embodiments, the central processor 2 may prompt the customer 10 for such preferences regarding payments, other account features, and other customer preferences. For instance the central processor 2 may prompt the customer 10 at the time the customer makes an otherwise delinquent payment. For instance, if $1000 is owed on the first of the month and the customer 10 pays only $800, the central processor 2 may prompt the customer 10 to select preferences regarding a revised payment schedule (such as a preference regarding an intended next payment).

### EXAMPLE 7

In some embodiments, the account may enable online access, flexible bill paying (e.g., including online billpay), and statement (e.g., activity statement) reporting capabilities. In some embodiments, the customer may be able to sort and subtotal account and rewards activity by account holder and by transaction classification. Bill payment flexibilities include pay in advance or defer and balance transfer functionality. In addition, ULOC funds may be transferred to deposit accounts (or other accounts) at one or more other banking institutions (e.g., in locations where the account provider institution does not have a bank branch).

### EXAMPLE 8

In some embodiments, the account may also have flexible pricing based on the customer's combined loan-to-value ratio (“CLTV”) or other metric associated with the customer's credit or ability to pay. CLTVs may take into account any portion of the account balance locked in (and/or unlocked) pursuant to the first-listed example (#1), above. CLTVs may also be influenced by other assets, such as a value of stocks owned by a customer or otherwise associated with the account.

In some embodiments, income from one account (such as a business-related account) or entity may be automatically transferred into a Bank account according to the present invention. The transfer may pay down a balance owed by the user. For instance, the transfer may be applied to pay a balance associated with a business-related account. In one embodiment, a customer may create an account associated with a line of credit, loan, or other source of funds in order to establish a business, such as an eBay™ venture wherein the customer receives funds, e.g., for the sale of goods or services (e.g., via an auction website). Income, such as payments for auctioned items, may be transferred in whole or part into the account. (Funds may pass through an intermediary account associated with the business activity, such as an eBay™ or Paypal™ account.) The funds may accordingly be applied to pay down a balance on a loan or other liability, such as to service the debt incurred to establish the business venture. The account may accordingly have some features similar to a business revolving account.

The proceeds of such income (e.g., any transfer of funds into the account) may be applied to the account balance or any desired payee. For instance, the funds may be transferred to pay a monthly payment, such as a monthly payment to cover a fixed rate loan or other amount owed by the account holder. The funds could also be automatically transferred to a third party via an automatic payment function in the account. For instance, 10% of an account holder's funds received through a particular portal (such as an eBay™ or Paypal™ account) could be automatically transferred through the Bank account to a payee such as a water company, car leasing company, or other lender or other entity the account holder intends to pay using the account.

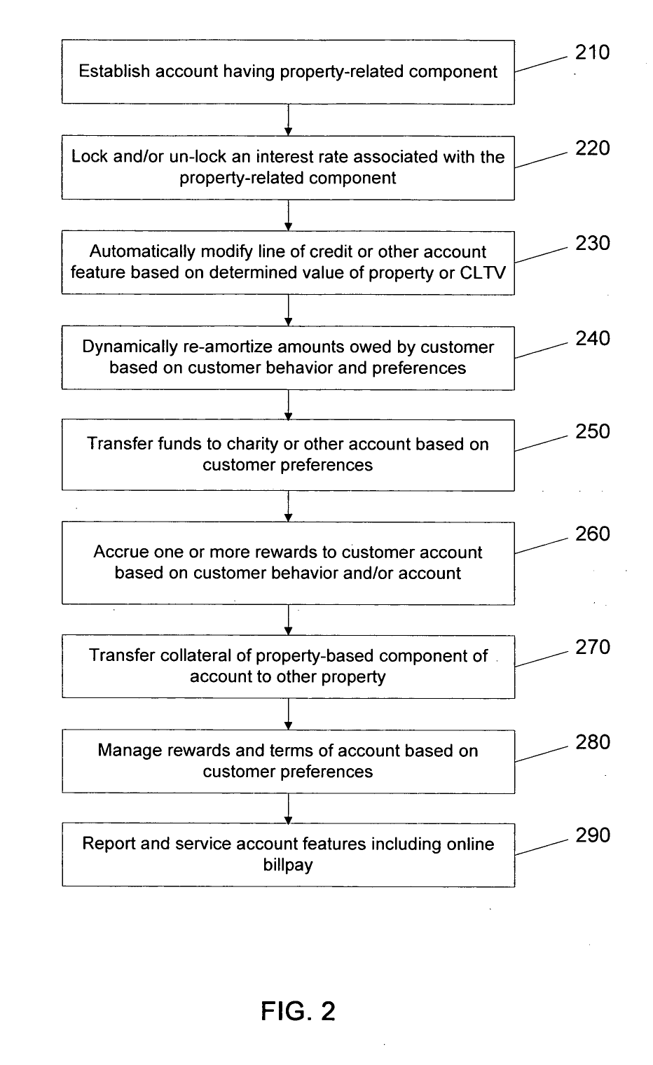

FIG. 2 shows an exemplary method of providing a financial account associated with a customer asset according to an embodiment of the invention.

In block 210, an account having a property-related component is established. For instance, a customer 10 having an account with a bank may add a ULOC to the account or convert the account into a ULOC account. Here, the home (or other property) securing the ULOC would be the property related to the account.

In block 220, an interest rate associated with the property-related component may be locked and/or unlocked, e.g., a number of times, e.g., as described in Example 1.

In block 230, a line of credit or other account feature may be modified (e.g., increased) based on a determined value of property or a CLTV (or other feature or variable), e.g., as described in Example 2.

In block 240, amounts owed by the customer based on customer behavior and preferences may be dynamically re-amortized, e.g., as described in Example 6.

In block 250, funds may be transferred to charity or to another account based on customer preferences, e.g., as described in Examples 3 and 4.

In block 260, one or more rewards may be earned and accrued to the customer's account, e.g., based on customer behavior, account activity, and/or other factors. For example, this action may be performed as described in Example 3.

In block 270, collateral related to the property-based component of account may be transferred to other property, e.g., as described in Example 5.

In block 280, rewards and terms of the customer's account may be managed based on customer preferences.

In block 290, account features including online billpay may be reported and serviced, e.g., as described in Example 7.

It should be appreciated that any of the above actions may occur in any order consistent with various embodiments of the present invention. Each action may occur one or more times during the life of the account.

Other embodiments may be considered.

It should also be appreciated that while the above-listed embodiments are described in reference to a preferred embodiment of a single account for providing such features, it should be appreciated that in some embodiments multiple accounts may be used to achieve these goals. For instance, a single primary account may comprise one or more separate or sub-accounts that are associated with a primary account. In some embodiments, the various accounts may have a centralizing feature; for instance, the accounts may all be tied to a single card, multiple cards, an RFID device, other key FOB, or other account access device (such as a personal financial manager, mobile phone, or payment access device with biometric security or identification feature), and/or the accounts may all belong to a single customer, and/or the accounts may all be provided by a single institution (e.g., including the institution's affiliates or partners), e.g., with unified reporting procedures (e.g., a single communication that includes account updates for all accounts).

The embodiments of the present inventions are not to be limited in scope by the specific embodiments described herein. For example, although many of the embodiments disclosed herein have been described with reference to property such as a home (e.g., a home loan or HELOC), the principles herein are equally applicable to other assets and/or interests, such as investment portfolios. Indeed, various modifications of the embodiments of the present inventions, in addition to those described herein, will be apparent to those of ordinary skill in the art from the foregoing description and accompanying drawings. Thus, such modifications are intended to fall within the scope of the following appended claims. Further, although the embodiments of the present inventions have been described herein in the context of a particular implementation in a particular environment for a particular purpose, those of ordinary skill in the art will recognize that its usefulness is not limited thereto and that the embodiments of the present inventions can be beneficially implemented in any number of environments for any number of purposes. Accordingly, the claims set forth below should be construed in view of the full breath and spirit of the embodiments of the present inventions as disclosed herein.

What is claimed is:

1. A method for providing a financial account associated with a customer asset, comprising:
establishing for a customer a financial account containing funds, at least a portion of the funds being secured by property owned by the customer, the account enabling the customer to:
draw funds from the account up to an account limit;
transfer funds from the account to another entity; and
deposit funds into the account;
after the establishing action, determining an appraised value of the property; and
automatically changing the account limit based on the determined appraised value.

2. The method of claim 1, wherein the appraised value is determined based on at least one of:
a value determined by an appraising entity;
a comparison of recent sales of one of more properties geographically-related to the property to prior sales of one or more properties geographically-related to the property; and
a metric that measures changes in property value.

3. The method of claim 2, wherein the appraising entity is a third party appraiser.

4. The method of claim 2, wherein the appraised value is determined by a computer system that determines the appraised value based on appraisal data.

5. The method of claim 4, further comprising:
automatically adjusting at least one of an insurance premium and an insurance coverage amount associated with the property based on the appraised value.

6. The method of claim 4, further comprising:
automatically adjusting at least one of an insurance premium and an insurance coverage amount associated with the property based on at least one of (i) a base insurance amount of a loan or line of credit and (ii) an exposure of a lending institution associated with the account by virtue of account funds secured by the property.

7. The method of claim 4, wherein the property is a house, and wherein the appraisal data comprises at least one of neighborhood value information, a distinguishing feature of the property to distinguish it from comparable properties, a premium house feature of the property, home improvement information, and school district performance information.

8. The method of claim 1, further comprising:
automatically adjusting at least one of an insurance premium and an insurance coverage amount associated with the property based on the appraised value.

9. The method of claim 1, further comprising:
locking in an interest rate associated with one or more payments owed by the customer for at least a portion of the secured funds.

10. The method of claim 9, wherein the property is a house, and wherein the interest rate is determined based on the intended use of the house.

11. The method of claim 10, further comprising:
after locking in the interest rate, unlocking the interest rate.

12. The method of claim 11, wherein the unlocked interest rate is a variable interest rate.

13. The method of claim 11, further comprising:
after unlocking the interest rate, locking in a second interest rate associated with one or more payments owed by the customer for an amount of money secured by the property.

14. The method of claim 9, wherein the at least a portion of the secured funds is a different amount than the amount of money secured by the property.

15. The method of claim 9, further comprising:
locking in an interest rate associated with one or more payments owed by the customer for an amount of money secured by an asset of the customer.

16. The method of claim 15, wherein the property is the same as the asset.

17. The method of claim 15, wherein the property is different from the asset, and wherein the secured funds has a different amount than the secured amount of money.

18. The method of claim 9, further comprising:
securitizing an asset comprising a plurality of debt instruments, wherein at least one of the debt instruments is associated with the property and the customer; and
selling the securitized asset in a secondary market.

19. The method of claim 1, wherein the determined value is an estimated fair market value.

20. The method of claim 1, further comprising:
increasing the credit limit a plurality of times based on corresponding determined appraised values of the property, wherein the credit limit cannot be increased beyond an increase amount.

21. The method of claim 1, further comprising:
receiving from the customer a designation of a charitable organization to receive funds from the account based on a triggering transaction;
automatically transferring money from the account to the charitable organization based on the triggering transaction.

22. The method of claim 21, wherein the money is automatically transferred to conform to a tax deduction standard so that the transfer is tax-deductible for the customer as a tax-deductible donation to the charitable organization.

23. The method of claim 1, further comprising:
automatically determining a payment schedule for payments owed by the customer for at least a portion of the secured funds.

24. The method of claim 23, further comprising:
determining that the customer has not made a payment according to the payment schedule;
automatically determining a differently amortized payment schedule based on preferences received from the user.

25. The method of claim 24, wherein the preferences received from the user comprises at least one of:
a preference to decrease one or more monthly payments;
a preference to increase one or more monthly payments; and
a preference to increase a term of the payment schedule;

26. The method of claim 24, further comprising:
accruing one or more rewards to the account based on at least one of account activity and customer behavior, wherein the one or more rewards comprises the right to at least one grace period for a missed payment specified by the payment schedule.

27. The method of claim 1, further comprising:
accruing one or more rewards to the account based on at least one of account activity and customer behavior.

28. The method of claim 1, wherein the property comprises collateral for the secured funds, further comprising:
transferring the collateral for at least a portion of the secured funds from the property to an asset different from the property, such that the asset secures the at least a portion of the secured funds and the property does not secure the at least a portion of the secured funds.

29. The method of claim 1, wherein the customer can withdraw funds from the account at an ATM machine.

30. The method of claim 1, further comprising:
issuing to the customer an access device configured to charge transactions against the account.

31. The method of claim 1, further comprising:
increasing the account limit based on account funds secured by an asset owned by the customer, wherein the asset is different from the property.

32. The method of claim 1, wherein the financial account comprises a universal line of credit (ULOC).

33. A system for providing a financial account associated with a customer asset, comprising:
an account creation module that establishes for a customer a financial account containing funds, at least a portion of the funds being secured by property owned by the customer, the account enabling the customer to:
draw funds from the account up to a credit limit;
transfer funds from the account to another entity; and
deposit funds into the account;
an appraisal module that determines an appraised value of the property after the establishing action; and
a credit module that automatically changes the credit limit based on the determined appraised value.

34. A method for providing a financial account associated with a customer asset, comprising:
establishing for a customer a financial account containing funds, at least a portion of the funds being secured by property owned by the customer, the account enabling the customer to:
draw funds from the account up to an account funding limit;
transfer funds from the account to another entity; and
deposit funds into the account;
receiving a request to lock in an interest rate associated with the at least a portion of the secured funds;
determining an amortized schedule of payments owed by the customer for the at least a portion of the secured funds;
re-amortizing the schedule of payments based on customer behavior;
issuing to the customer a transaction card configured to charge transactions against the account;
receiving a request made by the customer for cash drawn against the account;
after the establishing action, determining an appraised value of the property; and
automatically changing the account funding limit based on the determined appraised value.
